(19) United States
(12) Patent Application Publication
(10) Pub. No.: US 2019/0156363 A1
(43) Pub. Date: May 23, 2019

(54) IMPLEMENTATION OF A LOYALTY PROGRAM AND EXCHANGE SYSTEM UTILIZING A BLOCKCHAIN

(71) Applicant: Richard Postrel, Miami Beach, FL (US)

(72) Inventor: Richard Postrel, Miami Beach, FL (US)

(21) Appl. No.: 16/193,741

(22) Filed: Nov. 16, 2018

Related U.S. Application Data
(60) Provisional application No. 62/587,539, filed on Nov. 17, 2017.
(60) Provisional application No. 62/594,359, filed on Dec. 4, 2017.

(51) Int. Cl. G06Q 30/02; H04L 9/06; H04L 29/08

(52) U.S. Cl. CPC G06Q 30/0234; H04L 67/1042; H04L 9/0637; G06Q 30/0238

(57) ABSTRACT

A method of implementing a reward program and exchange system utilizing a blockchain comprising executing a reward transaction between a first party and a second party; the first party presenting a mobile device to the second party, the mobile device storing a blockchain ledger; the second party executing a permission routine requesting permission to add a reward transaction block to the blockchain ledger; if the permission routine grants permission to add a reward transaction block to the blockchain ledger, then generating a new reward transaction block as a function of a previous reward transaction block and the reward transaction being executed between the first party and the second party; adding the new reward transaction block to the blockchain ledger; and synchronizing the blockchain ledger with the second party.

### TECHNICAL FIELD

This invention relates to utilization of blockchains for implementing a reward program.

### BACKGROUND ART

Consumer loyalty programs, such as reward points programs, are prevalent in modern commerce. Many merchants that sell goods or services implement some type of loyalty program in which reward points or other types of artificial currency are provided to a customer for doing business with the merchant. Common examples include awarding of reward points to an account associated with a consumer when that consumer purchases a product from the merchant, awarding by an airline of frequent flier miles to a customer when that customer flies with that airline, awarding of reward points by a credit card issuer when the customer uses the credit card to make a purchase, etc. When the consumer reaches a certain plateau as set by the merchant, he may redeem the points for something of value. For example, a customer may accumulate 10,000 American Express Membership Rewards points and redeem them for a toaster. Many consumers are enrolled in upwards of twenty or more different loyalty programs.

Loyalty programs provide merchants with several advantages over its competitors, such as acquiring personal information from an enrolled customer (e.g. email address, telephone number and the like), as well as enticement of the customer to continue to use that merchant as it builds up more and more of that merchant's loyalty points in his account. For example, if a customer has flown on Delta Airlines in the past and has accumulated Delta Miles in his loyalty account, he is more likely to continue to use Delta in order to reach a certain goal of miles and be able to redeem the miles for a free flight.

One overarching problem with loyalty programs is that they are administered through centralized processing and storage systems, wherein a consumer has an account held by the merchant that indicates the number of points he has earned. That centralized account must be accessed in order to add points and redeem points. This requirement for a centralized system is costly and can be a deterrent from many merchants implementing loyalty programs.

Generally speaking, merchants seek to keep their loyalty programs discrete from any other program in order to maintain the goal of brand loyalty. However, there are certain situations in which various merchants form loyalty alliances with each other to further their business interests.

In one example, merchants form alliances with other merchants that provide non-competing, and often complimentary, products. As such, an airline may choose to link a customer with a preferred car rental partner so that the customer may obtain reward points of the car rental company in addition to or instead of airline miles. Similarly, that car rental company may link a customer with a preferred airline partner so that the customer may obtain reward miles of the airline in addition to or instead of points from the car rental company. This type of alliance does not disturb the competitive model and in fact provides synergies to each of the participating vendors.

In another example, reward points of one merchant may be exchanged or traded into another program, so that a consumer may have better redemption opportunities. For example, American Express Membership rewards points may be transferred into one or more partner programs such as Delta SkyMiles. In this case, a consumer may be able to exchange 10,000 Membership Rewards points into 10,000 SkyMiles, and combine them with his existing SkyMiles and redeem the combined total for a Delta flight.

Reference is also made to U.S. Pat. No. 6,594,640, SYSTEM FOR ELECTRONIC BARTER, TRADING AND REDEEMING POINTS ACCUMULATED IN FREQUENT USE REWARD PROGRAMS, the specification of which is incorporated by reference herein. In the '640 patent, methods and systems are described which enable consumers to exchange reward points of one program into another, accumulate points if desired, and exchange the accumulated points for products or services from a participating merchant.

Tensions exist between the merchants' desires to maintain strict brand loyalty and independence in administering their particular loyalty programs, and increasing market share through alliance and partnerships.

As a result of technological problems mentioned above (e.g. centralization requirements), as well as the aforementioned business deterrents, reward point programs have stagnated and not provided consumers with the full value they desire. The goal of the system and methods described herein is to overcome these technical and business deterrents and provide a loyalty system in which merchants and consumers may both benefit.

### DISCLOSURE OF THE INVENTION

The present invention is a system and methodology that implements a blockchain technology to provide a new loyalty and reward platform beneficial to both merchant and consumers. Blockchain is a new technology that provides a distributed ledger methodology that does not require a centralized control and storage system as in the past.

Blockchain is a continuously growing list of records, called blocks, which are linked and secured using cryptography. Each block typically contains a hash pointer as a link to a previous block, a timestamp and transaction data. By design, blockchains are inherently resistant to modification of the data. A blockchain can serve as an open, distributed ledger that can record transactions between two parties efficiently and in a verifiable and permanent way. For use as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority.

A digital wallet is created using a blockchain, which may be carried by a user in a portable device such as a smartphone, smartwatch, and the like. As the user executes a transaction, a merchant or other party with whom the user transacts may award reward points to that user by adding them to his blockchain ledger on his smartphone. In this manner, the user need not have an account stored at a centralized server computer as in the past, although the merchant may optionally keep its own records of the transaction centrally if so desired. As the user earns reward points from the merchant, his blockchain will be updated to reflect the additional points that have been earned. An application on the smartphone (or other device) may be implemented to enable the blockchain access. This application will also enable the user to determine how many points he has accumulated from a particular merchant.

At some point, the user may desire to redeem some or all of his points with that merchant. A redemption transaction would then take place in which the points required by the merchant for the redemption are deducted from the digital wallet in a subsequent blockchain transaction. The blockchain will keep a running record of all points added to the digital wallet as well as those taken from the wallet during the redemption process.

By using the blockchain ledger technology, the requirement for a centralized account is eliminated. Thus, when a consumer conducts a transaction with a merchant in a chain store, the rewards transaction is recorded in the blockchain with requiring a central server. The consumer may then visit another store in the chain at a different location, conduct a transaction, and have a subsequent rewards transaction recorded for the store chain in his blockchain ledger. Again, this does not require the use of a central server since the blockchain ledger provides the digital wallet functionality.

Additionally, the use of a blockchain methodology in accordance with this invention provides the ability for parties including merchants, issuers, redeemers, and consumers to collaborate with each other without requiring any of the parties to have predetermined relationships established as in the prior art. Because the blockchain ledger is an independent entity and accessible to all parties independently, collaboration as required in the prior art is not required in this invention.

Implementation of the digital wallet with a blockchain ledger provides a carry-forward functionality not found in loyalty systems of the prior art. A consumer may earn rewards at each step of the chain, which are added piece by piece to his blockchain ledger. Different merchants may utilize different rules as desired, and the blockchain ledger will reflect implementation of those rules by the merchants as the user interacts and transacts business with those merchants.

Award and redemption rules may be changed on the fly by each merchant as desired, since the interactions with the blockchain at the point of sale does not require a centralized methodology as in prior art reward systems. These rules may apply to individual consumers, blocks of consumers, all consumers, etc., as may be desired by the merchant. Thus, each merchant may tailor its reward program and customize it instantaneously if desired.

By using the decentralized blockchain ledger as a digital wallet, synergies are realized not possible in the prior art. Alliances and coalitions between merchants may be formed, modified, dissolved, etc. in an instantaneous fashion, wherein blockchain rules may be adapted by each merchant along the chain. This provides an agile, modifiable ecosystem for providing and redeeming rewards amongst multiple merchants. Likewise, multiple consumers may be formed into groups by linking their blockchain ledgers without requiring a centralized server. For example, members of a family may form a group that can share reward points amongst them, accumulate them for increased rewards, trade rewards, etc.

In one embodiment, individual merchants that do not otherwise offer a loyalty program (so-called “orphans”) may choose to participate at any time as a result of a transaction with a customer. For example, a small store, not part of a large chain and therefore unable to provide a loyalty program due to otherwise high cost, may offer a “one-off” reward to its customer at the time of the transaction or otherwise. Thus, the use of the blockchain as the platform for loyalty enables participation by these orphan merchants in ways otherwise unattainable in the prior art loyalty systems. These merchants may also choose when and how to redeem points from the blockchain if desired.

By use of the blockchain ledger in the present invention, rewards may be modified in the ledger after they have been awarded. For example, rewards that have been added to a blockchain ledger may be varied as a function of time. Rewards may be reduced in value over time, which may provide an incentive for a consumer to redeem them rather than have them be reduced. This reduction in value need not follow any particular predetermined formula and may be varied in the ledger at will by the merchant that has awarded them. Also, rewards may be varied as a function of volume, whereby changes increase in rewards given by a merchant to its customers may cause the merchant to want to reduce the value of rewards already distributed in order to decrease the overall liability of the rewards issuer.

The blockchain-based reward methodology described herein provides an arbitrage environment in which valuations of rewards awarded to a blockchain ledger may be varied based on various market conditions, values of other rewards platforms, etc. Notably, reward points awarded by one issuer may be exchanged for other reward points awarded by a different vendor, and vice-versa. In one embodiment, the user has control over this exchange, in which permission may be needed from one or both of the issuers. In another embodiment, the issuers control how the reward points are exchanged to or from another issuer in the user's blockchain ledger, operating passively with respect to the user who has little or no control over that exchange process.

In one embodiment, this rewards exchange methodology, in which reward points are exchanged from one issuer's points into another issuer's points, may be extended so that reward points are aggregated from various issuers into one reward exchange account. This would operate in a similar manner to the reward exchange and aggregation methodology described in my '640 patent mentioned above, except that the reward accounts are not stored in various server computers on the internet, but rather those accounts are located in a single blockchain ledger that would be part of the user's digital wallet.

The blockchain ledger based reward system described herein also has great applicability to social networking. Reward-based blockchains may be distributed, modified, adapted etc. by various members of a user's social network, with permissions for ledger access being provided based on social network status. Users may form coalitions to merge and exchange points amongst ledgers of various members within their social network, providing synergies otherwise unattainable in legacy reward systems.

In one related aspect, a scoring methodology is employed that operates on data stored within the blockchain ledger, and which is updated and revised as data in that ledger changes. Sources of data within the blockchain would include the value of transactions, the type of transactions, rewards that are awarded and/or redeemed for a transaction, and the like. The user may have a profile that gives him control over the data utilized in the scoring model, which will alleviate privacy concerns. For example, the user may want to allow the value of a transaction to be used in the scoring model, but not the type of product purchased or the merchant that the product is purchased from. Filters may be applied based on various data types, and the user may modify the profile as desired.

The scoring model may be implemented by an app operating in conjunction with the blockchain, for example residing on the device carrying the blockchain such as a smartphone. The user's score would be stored in the blockchain and accessible via outside parties as allowed by the user. For example, as part of a transaction, a merchant may access the user's score from the blockchain (and/or any supporting data from the blockchain if allowed by the user), which can be used to tailor the transaction to that user in a more beneficial manner. This score may act as a Q rating, similar to what is used to rate celebrities. The score may tie into and/or be based on the user's social network parameters as well.

In addition to user's implementing blockchain for loyalty and other transaction-based parameters, merchants may also implement a blockchain paradigm under this invention. That is, a merchant may carry a blockchain that contains data regarding transaction with customers, rewards that have been awarded, rewards that have been redeemed, etc.

In another embodiment, a user may have a blockchain used to recording, analyzing and maintaining records regarding his or her driving habits. For example, a blockchain may be used to record the point and time of entry of a vehicle onto a toll road, the point and time of exit, the average speed by the vehicle based on the entry and exit times/points, a fine that may be levied if the user has exceeded the posted speed limit based on the calculated average speed, payment of the fine, data to be reported to the user's insurance company regarding the fine, and the like.

Thus provided is a method of implementing a reward program and exchange system utilizing a blockchain comprising executing a reward transaction between a first party and a second party; the first party presenting a mobile device to the second party, the mobile device storing a blockchain ledger; the second party executing a permission routine requesting permission to add a reward transaction block to the blockchain ledger; if the permission routine grants permission to add a reward transaction block to the blockchain ledger, then generating a new reward transaction block as a function of a previous reward transaction block and the reward transaction being executed between the first party and the second party; adding the new reward transaction block to the blockchain ledger; and synchronizing the blockchain ledger with the second party.

The permission routine requests permission to add a reward transaction block to the blockchain ledger by ascertaining the identity of all parties with an interest in the reward transaction; requesting permission from all identified parties to add the reward transaction block to the blockchain ledger; if any of the identified parties denies permission, then requesting an override from a system administrator; if all of the identified parties grants permission, or if all permission denials are overridden by the system administrator, then granting permission to add a reward transaction block to the blockchain ledger.

Generating a new reward transaction block as a function of a previous reward transaction block and the reward transaction being executed between the first party and the second party includes logging a timestamp of the reward transaction; calculating a hash of reward transaction data, and entering the timestamp, the calculated hash, and the reward transaction data as the new reward transaction block into the blockchain ledger.

If the reward transaction is a reward issuing transaction, then the reward transaction data includes the rewards being issued for the transaction and an identification of the reward issuing party. If the reward transaction is a reward redemption transaction, then the reward transaction data includes the rewards being redeemed for the transaction and an identification of the reward redeeming party. If the reward transaction is a reward exchange transaction, then the reward transaction data includes the rewards being exchanged for the transaction and an identification of a reward issuing party and a reward redeeming party.

### BRIEF DESCRIPTION OF THE DRAWING

FIG. 1 is a basic block diagram of the preferred embodiment of the invention.

FIG. 2 is an illustration of a blockchain reward ledger in accordance with the preferred embodiment of the invention.

FIG. 3 is a flowchart of a general process for executing a transaction with a blockchain reward ledger in accordance with the preferred embodiment of the invention.

FIG. 4 is a flowchart of a process used for obtaining permission for modifying the blockchain ledger in the process of FIG. 3.

FIG. 5 is a flowchart of a process used for entering a transaction into the blockchain reward ledger.

FIG. 6 illustrates an exemplary process for exchange rewards points from those of one issuer into those from another issuer.

FIG. 7 is a flowchart of a process used for obtaining permission for modifying the blockchain ledger in the process of FIG. 6.

FIG. 8 is a flowchart of a process used for executing the blockchain reward exchange process.

### DETAILED DESCRIPTION OF THE PREFERRED EMBODIMENTS

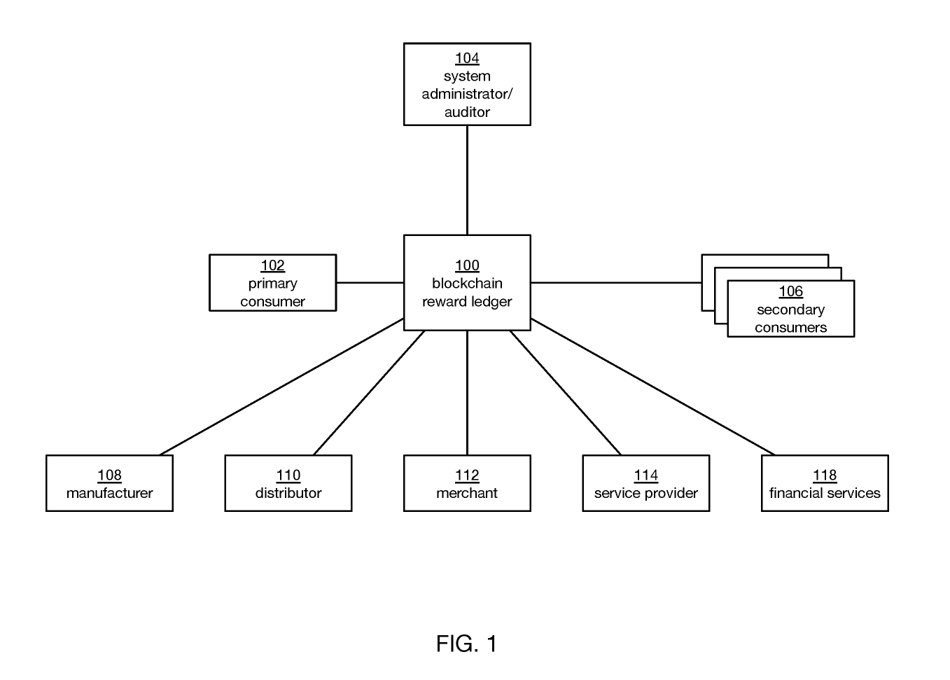

With reference to FIG. 1, the overall system will now be described. FIG. 1 illustrates various parties that may interact with a blockchain reward ledger 100. The blockchain reward ledger 100 is a secure digital file or set of files that resides on a mobile device such as a smartphone, wearable device, etc., as may be desired. Since the primary consumer 102 will want to utilize his blockchain reward ledger 100 at many different locations and times, the blockchain reward ledger is preferably part of a mobile device. In the alternative, the blockchain reward ledger may reside on a device that is not mobile, but it is preferred to keep it on a mobile device, in particular since that mobile device will likely also contain a payment mechanism utilized by the primary consumer 102. The blockchain reward ledger 100 may reside within or in conjunction with a digital wallet on the mobile device, which may store other items of value such as bitcoins, credit card information, etc.

The various parties shown on FIG. 1 are illustrative of those parties that may interact with the blockchain reward ledger 100, but it is not exhaustive. For example, these parties may include manufacturers 108, distributors 110, merchants 112, service providers 114, and/or financial services 118. Also shown are secondary consumers 106, each of whom will have a blockchain reward ledger stored on their own mobile devices, which may interact with the blockchain reward ledger 100 of the primary consumer 102 as will be explained further herein. For example, a secondary consumer 106 may be a friend (or family member) of the primary consumer 102, who wishes to transfer some of his rewards from his blockchain reward ledger 100 to such friend.

In this illustrative example, a primary consumer 102 that owns the blockchain reward ledger 100 on his mobile device, and who interacts with any or all of these parties, is also referred to simply as a consumer 102.

For illustrative purposes, an exemplary transaction utilizing the blockchain reward ledger 100 of the preferred embodiment herein occurs between the consumer 102 and a merchant 112, although the process may be the same or similar for the other parties in the system.

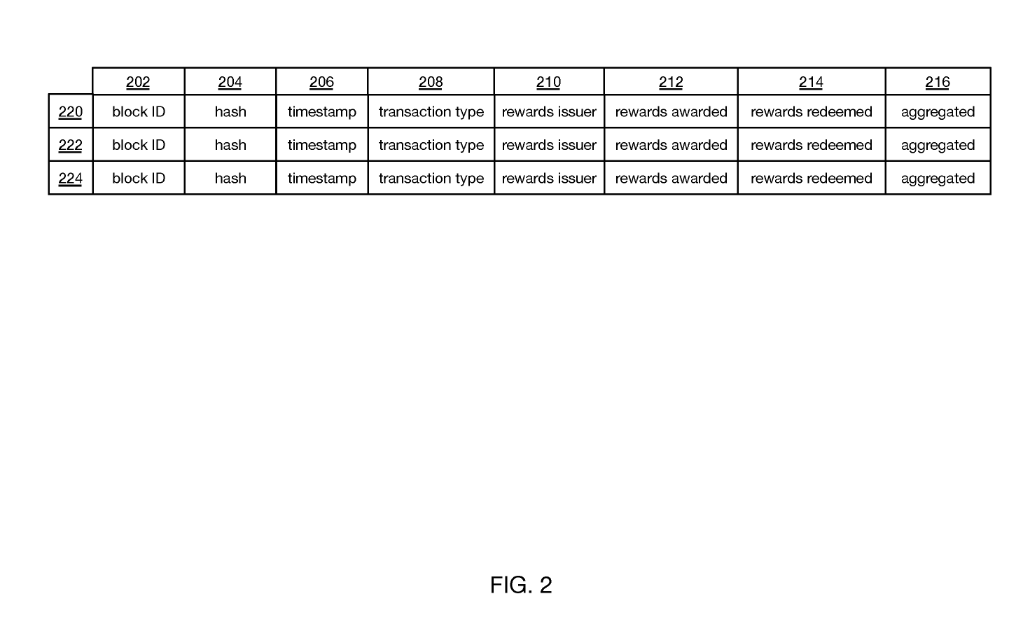

FIG. 2 shows an illustration of a typical blockchain reward ledger 100 in accordance with the preferred embodiment of the invention. Shown are several blocks 220, 222, 224, each of which have the same records fields, including block ID 202, hash 204, timestamp 206, transaction type 208, rewards issuer 210, rewards awarded 212, rewards redeemed 214, and rewards aggregated 216. Other transaction fields of course may be included in each block as desired.

Block ID 202 acts as a unique identifier for each block in the ledger 100. Hash 204 is a hash pointer as a link to a previous block so that a sequence of block events may be provided. Timestamp 206 provides date and time information for the entry of the bock into the ledger 100. The remaining fields comprise the transaction data as follows. Transaction type 208 sets forth the type of reward transaction occurring in the block (e.g. award of rewards, redemption of rewards, exchange of rewards, etc.). Rewards issuer 210 identifies the issuer of the rewards that are either being awarded or redeemed in the block (e.g. the merchant). Rewards awarded 212 identifies, both quantitatively and qualitatively, the rewards that have been awarded to the consumer 102 in the block, if the block is for a reward-awarding transaction (e.g. a purchase of a product from the merchant for which the consumer 102 is granted 15,000 reward points from the merchant). Rewards redeemed 214 identifies, both quantitatively and qualitatively, the rewards that have been redeemed by the consumer 102 in the block, if the block is for a reward-redeeming transaction (e.g. a purchase of a product from the merchant for which the consumer 102 uses 10,000 reward points to pay for the product from the merchant). Rewards aggregated 216 is a field or series of fields that may be used to identify rewards that are being aggregated together, if the block is for a reward aggregation transaction (e.g. 10,000 reward points from one merchant are aggregated with 12,000 reward points from another merchant to provide an aggregate total of 22,000 reward points, assuming a 1:1 conversion ratio). Other fields may be included in the block if necessitated by the particular transaction that is occurring between the consumer 102 and the merchant 112 (or any other of the parties shown in FIG. 1).

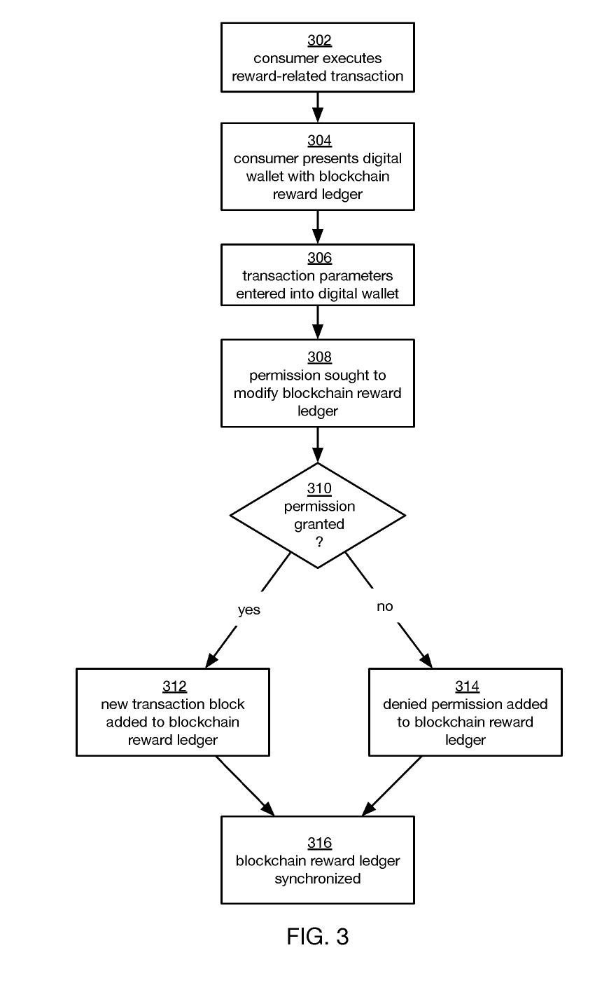

FIG. 3 is a flowchart of a general process for executing a transaction with a blockchain reward ledger in accordance with the preferred embodiment of the invention. In step 302, the consumer 102 executes a reward-related transaction with a party as shown in FIG. 1. For example, the consumer 102 purchases a product from a merchant 112, for which he will receive reward points that will be added to his blockchain reward ledger 100. In step 304, as part of the purchase transaction, the consumer presents to the merchant a digital wallet that contains the blockchain reward ledger 100. The digital wallet may be a program or app that executes on the consumer's mobile device, and it may provide a payment mechanism such as bitcoin, ethereum, or more traditional payment means such as a credit card. Payment using a digital wallet program on a mobile device is known in the art and need not be described in further detail herein.

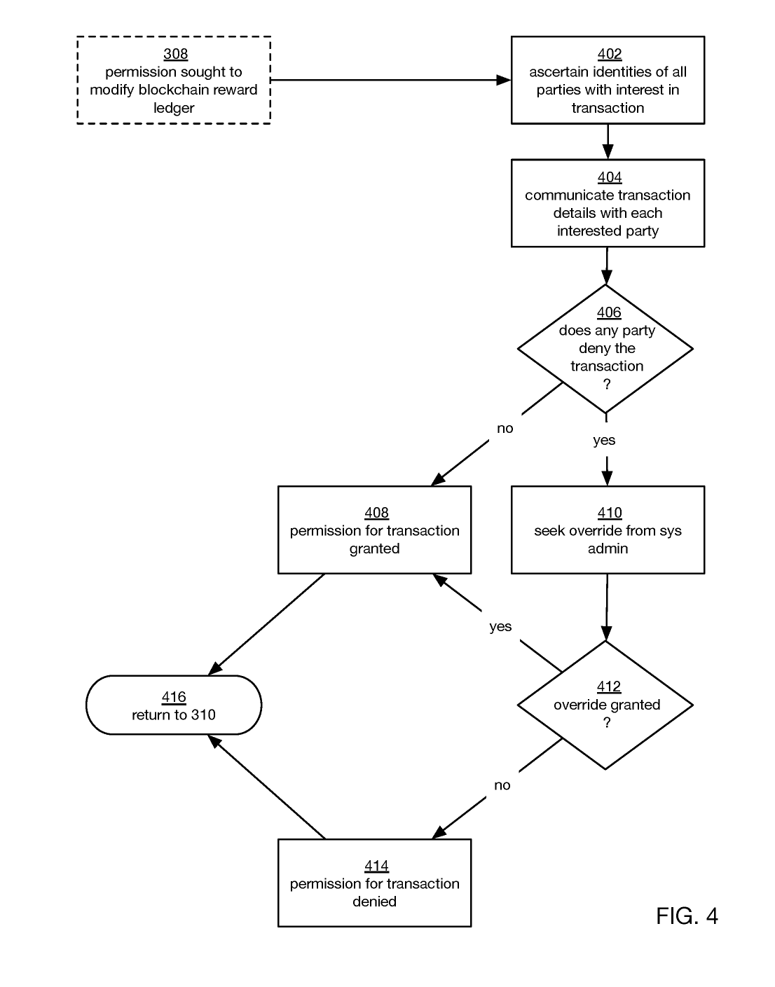

At step 306, the transaction parameters are entered into the digital wallet, such as the purchase price, payment vehicle, etc. At this point, the reward points will be attempted to be added to the blockchain reward ledger 100 as follows. As a preliminary process, permission is sought at step 308 for the blockchain ledger to be modified by adding the reward transaction as a new block. This sub-process is described in further detail with respect to FIG. 4 as follows.

At step 402, the identities of all parties having an interest, pecuniary or otherwise, in the transaction, are ascertained. In the simple example of a transaction in which the consumer purchases a product from a merchant and the merchant awards reward points, the merchant will have a pecuniary interest in the transaction. This may require permission to be sought from a central authority at the merchant, for example an administrator for the merchant, its financial department, and the like. Another interested party may be the issuer of the credit card used by the consumer, since reward points may be awarded if a certain credit card is used. For example, the consumer may receive Membership Rewards points from American Express if the consumer uses American Express to make the purchase from the merchant. These reward points may be independent from those awarded by the merchant, who may for example be Best Buy.

Thus, at step 404, the details of the purchase transaction, and/or the reward points sought to be awarded as a result of the transaction, will be communicated by means known in the art to each interested party. At step 406, if none of the parties denies the proposed transaction, then permission is granted for the transaction to proceed at step 408, and the process returns at step 416 to the main process step 310. If, however, any of the interested parties denies the transaction, then an override of the denial by the system administrator may be sought at step 410. If the system administrator does not grant the override, then permission is denied for the transaction to proceed at step 414, and the process returns at step 416 to the main process step 310. If, however, the system administrator does grant the override, then permission is granted for the transaction to proceed at step 408, and the process returns at step 416 to the main process step 310.

Returning back to the main process at FIG. 3, if the result of the permission process in

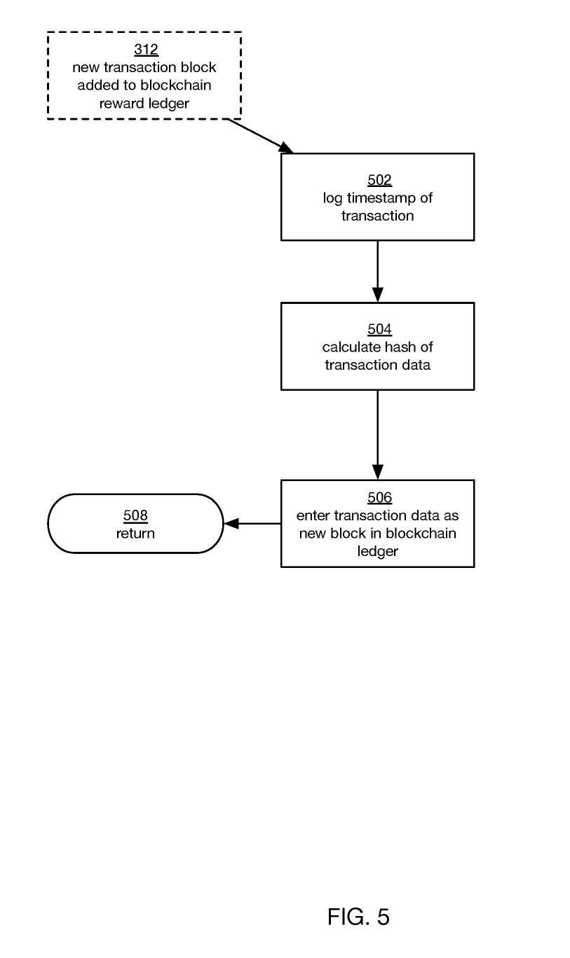

FIG. 4 as described above is that permission is not granted, then permission is denied for access to the blockchain ledger at step 314, and (optionally) the denial of permission is recorded in the ledger 100. If, however, the result of the permission process is that permission is granted, then a new transaction block is added at step 312 to the blockchain reward ledger 100 as shown in the sub-process of FIG. 5. At step 502, the timestamp of the transaction (date, time) is logged, and at step 504, a hash of all data in the transaction block is calculated. That data along with the transaction data is entered into the blockchain ledger on a permanent basis.

After the blockchain reward ledger 100 has been modified, then it is synchronized across multiple parties at step 316. Synchronization is a process in which a duplicate of the transaction block generated and entered as a result of the transaction is transmitted to all interested parties, i.e. those whose permission was sought in the prior steps. This block is thereby maintained independently by all interested parties, and the process terminates.

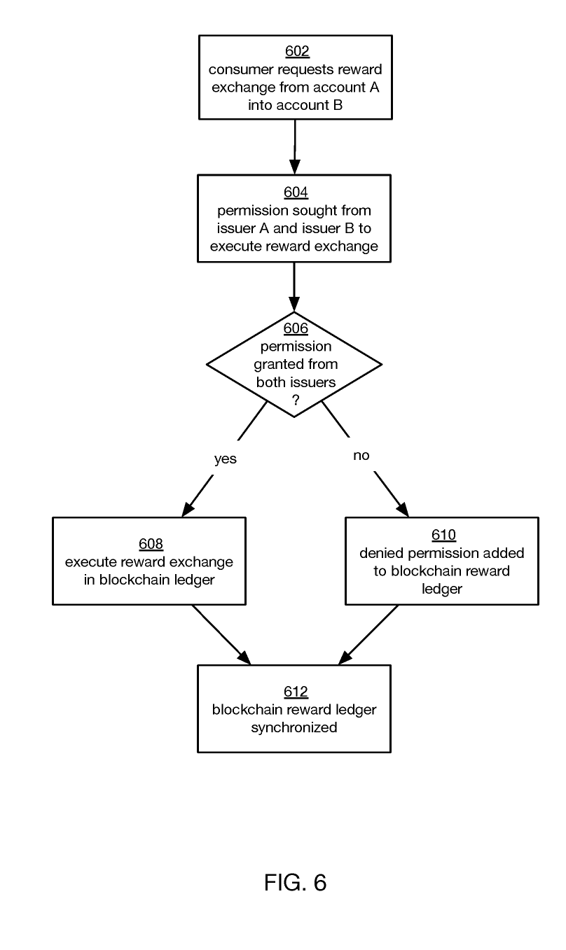

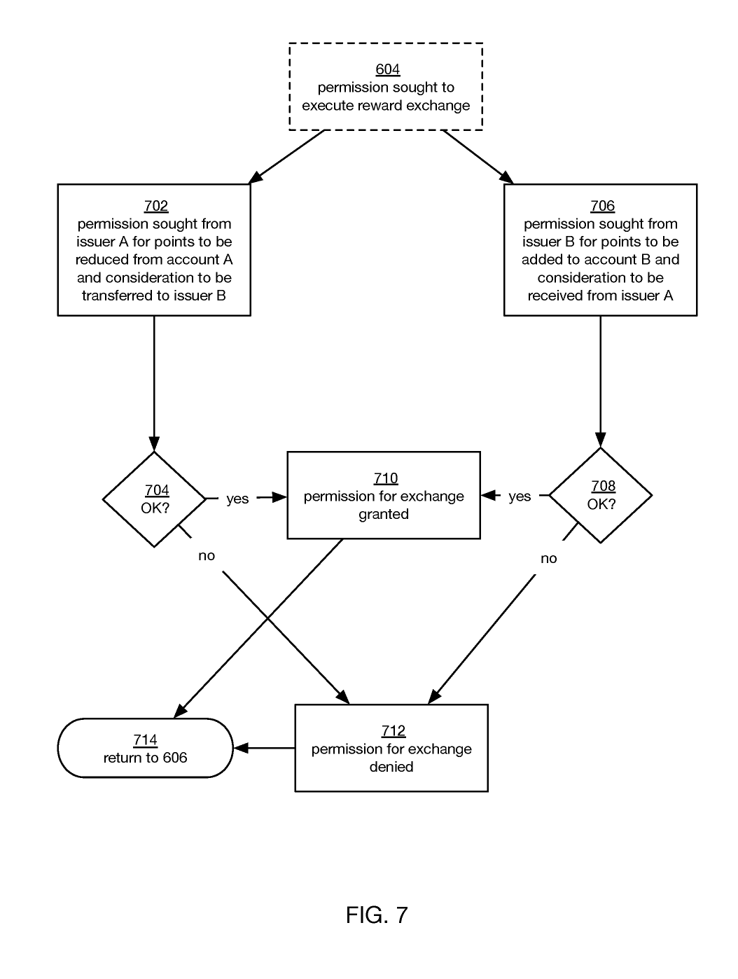

In another embodiment, a consumer may be able to exchange reward points from one of his accounts into another of his accounts, both of which reside within or in close association with his blockchain reward ledger. FIG. 6 illustrates an exemplary process for this embodiment. At step 602, the consumer requests a reward points exchange from his account A into his account B. For example, the consumer may want to exchange (also known as a trade or transfer) 5,000 Membership Rewards points, originally issued by American Express, into Delta Sky Miles, so he may purchase flight on Delta. In this example, American Express is issuer A and Delta is issuer B. At step 604, permission is sought for executing this exchange from both issuer A and issuer B. That is, either party can deny the requested exchange transaction. This is shown in further detail in FIG. 7. At step 702, permission is sought from issuer A for points to be reduced from the consumer's account A on his mobile device and consideration to be transferred to from issuer A to issuer B in order to compensate issuer B for the liability it is now undertaking to consumer A for the increase in points in account B. If issuer A denies this request at step 704, then permission for the exchange is considered to have been denied at step 712 and the process returns at step 714 to step 606 of FIG. 6. Likewise, at step 706, permission is sought from issuer B for points to be added to account B and consideration to be received from issuer A. If issuer B denies this request at step 708, then permission for the exchange is considered to have been denied at step 712 and the process returns at step 714 to step 606 of FIG. 6.

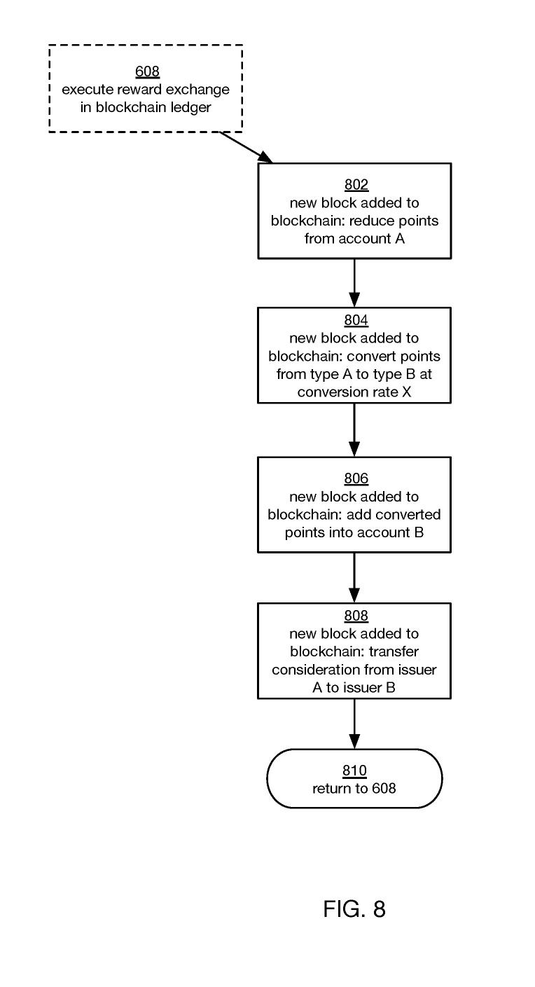

If, however, both issuers A and B grant permission for the exchange at step 710 as requested, then the process returns at step 714 to step 606 of FIG. 6. Returning back to the main process at FIG. 6, if the result of the permission process in FIG. 7 as described above is that permission is not granted, then permission is denied for access to the blockchain ledger at step 610, and (optionally) the denial of permission is recorded in the ledger 100. If, however, the result of the permission process is that permission is granted, then the exchange process executes at step 608 as shown in detail in FIG. 8.

At step 802 of FIG. 8, a new block is added to the blockchain ledger, which reduces reward points from account A in the requested amount. In the above example, 5,000 Membership Rewards points are indicated to be decreased from the consumer's Membership Reward account on his mobile device. At step 804, a new block is added to the blockchain ledger, which converts points from type A to type B at conversion rate X. In the above example, 5,000 Membership Rewards points are converted to 5,000 Delta Sky Miles, assuming that the conversion rate X is 1:1. At step 806, a new block is added to the blockchain ledger, which adds the converted points into account B. In the above example, the 5,000 converted SkyMiles are added to the consumer's Delta SkyMiles account on his mobile device. At step 808, a new block is added to the blockchain ledger, which transfers consideration from issuer A to issuer B. In the example above, $50 is transferred from American Express to Delta, since the 5,000 points are valued in this example at one penny per point. Of course, other values may be used. The process returns at step 810 to step 608 of FIG. 6.

After the blockchain reward ledger 100 has been modified as described, then it is synchronized across multiple parties at step 612. Synchronization is a process in which a duplicate of the transaction block generated and entered as a result of the transaction is transmitted to all interested parties, i.e. those whose permission was sought in the prior steps. This block is thereby maintained independently by all interested parties, and the process terminates. In this case, the blocks are synchronized with issuers A and B.

In another aspect, a bifurcated solution is provided utilizing a blockchain wherein anonymity of users may be maintained and wherein transparency of various transactions is provided. Different entities or groups of entities may be rated, e.g. for insurance purposes, and that may be part of a segment of the blockchain ledger. A trading environment may thereby be created in which various jurisdictions/governments have control of the ledger(s) to limit the differentials, swings and exposure. Other applications may include dating with blockchain ledgers, travel with blockchain, and employment.

In another aspect, groups of consumers may form their own alliance (i.e. their own affinity group) by combining their blockchain ledgers. That is, these consumers can generate new transaction blocks that are recorded into their ledgers that reflect the alliances with each other, and that cross-reference each other. As such, each consumer will have a record in their blockchain ledges of every other consumer in their alliance, they can exchange/trade reward points, cross-redeem, and the like. Each time an intra-alliance transaction occurs, each blockchain ledger that is part of the alliance will record the transaction accordingly.

What is claimed is:

1. A method of implementing a reward program and exchange system utilizing a blockchain comprising:
a. executing a reward transaction between a first party and a second party;
b. the first party presenting a device to the second party, the device storing a blockchain ledger;
c. the second party executing a permission routine requesting permission to add a reward transaction block to the blockchain ledger;
d. if the permission routine grants permission to add a reward transaction block to the blockchain ledger, then
i. generating a new reward transaction block as a function of a previous reward transaction block and the reward transaction being executed between the first party and the second party;
ii. adding the new reward transaction block to the blockchain ledger; and
e. synchronizing the blockchain ledger with the second party.

2. The method of claim 1 wherein the permission routine requesting permission to add a reward transaction block to the blockchain ledger comprises
i. ascertaining the identity of all parties with an interest in the reward transaction;
ii. requesting permission from all identified parties to add the reward transaction block to the blockchain ledger;
iii. if any of the identified parties denies permission, then requesting an override from a system administrator;
iv. if all of the identified parties grants permission, or if all permission denials are overridden by the system administrator, then granting permission to add a reward transaction block to the blockchain ledger.

3. The method of claim 1 wherein the step of generating a new reward transaction block as a function of a previous reward transaction block and the reward transaction being executed between the first party and the second party comprises
1. logging a timestamp of the reward transaction
2. calculating a hash of reward transaction data, and
3. entering the timestamp, the calculated hash, and the reward transaction data as the new reward transaction block into the blockchain ledger.

4. The method of claim 3 wherein the reward transaction is a reward issuing transaction, and wherein the reward transaction data comprises the rewards being issued for the transaction and an identification of the reward issuing party.

5. The method of claim 3 wherein the reward transaction is a reward redemption transaction and wherein the reward transaction data comprises the rewards being redeemed for the transaction and an identification of the reward redeeming party.

6. The method of claim 3 wherein the reward transaction is a reward exchange transaction and wherein the reward transaction data comprises the rewards being exchanged for the transaction and an identification of a reward issuing party and a reward redeeming party.

7. The method of claim 1 wherein the device is a mobile device.
